(19) United States
(12) Patent Application Publication
(10) Pub. No.: US 2003/0043292 A1
(43) Pub. Date: Mar. 6, 2003

(54) System and method for automatic capture of light producing scenes

(76) Inventors: Norman C. Pyle, Greeley, CO (US); Miles Thorland, Fort Collins, CO (US)

Correspondence Address: HEWLETT-PACKARD COMPANY, Intellectual Property Administration, P.O. Box 272400, Fort Collins, CO, 80527-2400, US

(21) Appl. No.: 09/945,033

(22) Filed: Aug. 31, 2001

(51) Int. Cl. H04N 5/238; H04N 9/73; H04N 5/232

(52) U.S. Cl. 348/364; 348/231.6; 348/211.99; 348/227.1

(57) ABSTRACT

The image capture device detects a sudden light change event and captures images associated with the sudden light change event. Exposure values associated with the captured images are calculated. The difference between the exposure values are compared to an exposure value change criteria. If the difference is at least equal to the exposure value change criteria, the presence of a sudden light change event is determined and the most recently captured image is saved into memory. Thus, only images associated with the sudden light change event are saved, thereby more efficiently utilizing limited memory capacity. The sudden light change event is typically characterized by a relatively large, sudden and unpredictable increase in light such that the object of interest is more lighted. Also, after the onset of the sudden light change event and/or before the onset of the sudden light change event, images may be stored in memory.

### BACKGROUND OF THE INVENTION

1. Field of the Invention

The present invention generally relates to recording and processing digital images and, in particular, to a system and method for capturing a light-producing image with an image capture device.

2. Related Art

Often a photographer desires to capture or “photograph” an event that is associated with a light producing phenomena. For example, but not limited to, the photographer may want to capture images that are lighted by a lightning strike, explosion, fire, firework displays or the like. At other times, the photographer may want to capture the light producing event itself.

Other events of interest may be defined by sudden, unpredictable change in ambient lighting levels. For example, the nature photographer may desire to photograph a large cat in the jungle at night from an unattended site. The photographer would set up a trip wire, motion detector or the like that activates one or more lights to provide ambient lighting for photographing the cat. The cat's presence at the site activates the lights, thus indicating that the photographing process should begin.

In the above exemplary situations where a light producing event indicates that image capturing should occur, image capturing may be in a still image format or in a video image format. That is, the photographer may desire a single photograph of the event, a series of time sequenced still images of the event, or a video image of the event. For example, the photographer may wish to capture a single image of a tree lighted by lightning. Alternatively, the photographer may wish to capture a series of still images illustrating the lightning strike to the tree, thus having a choice of images such that the moist desirable image(s) may be selected. Or, the photographer may wish to capture a video image of the lightning strike to the tree and the subsequent burning of the tree. One skilled in the art will appreciate that the types of events that may be identified by a change in lighting conditions are limitless.

With the advent of digitally based image recording devices capable of “photographing” an image and providing the image in a digital data format, a digital “photograph” of the image may be captured sand stored using a digital memory system that stores the digital data corresponding to the image. Alternatively, conventional film cameras capture the image in a film format. The film is later processed after exposure of the film to the photographed image. Digital cameras and film cameras may be configured to capture still and/or video images. Furthermore, such digital and/or film cameras may be configured to capture audio data associated with the captured event.

However, image recording capacity available to conventional film cameras or available to digital cameras is limited. The film camera is limited by the amount of film residing in the film camera. When the film is fully exposed, no additional images may be captured. The digital camera is limited by the available memory storage capacity. When the memory is fully utilized by the stored digital image data, no additional images may be captured. If the digital camera is storing audio information in the memory, then the number of digital images that can be stored is further limited.

Thus, a heretofore unaddressed need exists in the industry for providing a system and method of controlling the capturing of images associated with the light producing event, thereby allowing the camera to more efficiently and effectively utilize the limited available image storage medium (memory in a digital camera) or the limited available recording medium (film in a conventional film camera).

### SUMMARY OF THE INVENTION

The present invention overcomes the inadequacies and deficiencies of the prior art as discussed hereinabove. Generally, the present invention, an image capture device, provides a system and method for detecting a sudden light change event and to capture images associated with the sudden light change event.

In one embodiment, a digital camera determines a first exposure value, or reference exposure value, associated with a captured image. After the next image is captured, a second exposure value associated with the next image is determined. The difference between the reference exposure value and the second exposure value is compared with an exposure value change criteria. If the difference is at least equal to the exposure value change criteria, the presence of a sudden light change event is determined and the second image is saved into memory. If the difference is less than the exposure value change criteria, no sudden light change event has occurred and the second image is discarded. Thus, only images associated with the sudden light change event are saved, thereby more efficiently utilizing limited memory capacity.

The sudden light change event is typically characterized by a relatively large, sudden and unpredictable increase in light such that the object of interest is more lighted. However, the sudden light change itself may be the object of interest. Also, the sudden light change event may be characterized by a decrease in light.

In another embodiment, images captured after the onset of the sudden light change event are stored in memory. In another embodiment, images captured before the onset of the sudden light change event are stored in memory. Captured digital still and/or video images are saved into memory depending upon the configuration of the image capture device. In another embodiment, the image capture device is a film camera for capturing still photographs or video movies such that the detection of a sudden light change event causes the film camera to take a photograph.

The present invention can also be viewed as providing a method for determining an exposure value for the image, computing an exposure value change from a previous exposure value, comparing the exposure value change to an exposure value change criteria and capturing the image when the exposure value change is at least equal to the exposure value change criteria.

Other features and advantages of the present invention will become apparent to one skilled in the art upon examination of the following detailed description, when read in conjunction with the accompanying drawings. It is intended that all such features and advantages be included herein within the scope of the present invention and protected by the claims.

### BRIEF DESCRIPTION OF THE DRAWINGS

The invention can be better understood with reference to the following drawings. The elements of the drawings are not necessarily to scale relative to each other, emphasis instead being placed upon clearly illustrating the principles of the invention. Furthermore, like reference numerals designate corresponding parts throughout the several views.

FIG. 1 is a block diagram illustrating selected internal components residing in a digital image capture device incorporating the exposure change detection system.

FIG. 2 is an illustrative diagram showing the deployment of the digital image capture device of FIG. 1 in the field to capture images associated with a sudden, unpredictable light change.

FIG. 3 is a time line diagram illustrating the exposure change analysis process employed by the digital image capture device of FIG. 1.

FIG. 4 is a chart illustrating three exemplary sudden light change events.

FIG. 5 is a flow chart illustrating the process of capturing images using the digital cameras of FIG. 1.

FIG. 6 is a block diagram illustrating an alternative embodiment of an image capture device employing a light detector.

FIG. 7 is a block diagram illustrating an alternative embodiment of an image capture device employing a remote light sensing unit.

### DETAILED DESCRIPTION OF THE INVENTION

a. Overview of the Exposure Change Detection System

In general, the present invention relates to a system and method for detecting sudden changes in light such that an imaging capturing device, such as a digital camera that captures still and/or video images, captures images of interest associated with the light change event. Alternative embodiments are implemented in conventional film based image capture devices, such as film cameras and motion picture cameras. The ambient light level and/or lighting of the object of interest is monitored.

In one embodiment, the light level associated with one image captured by the digital camera is analyzed to determine the lighting level associated with that image or a portion of that image. The lighting level of the image, or the portion of the image, is hereinafter referred to as the exposure value of the image. The exposure value is defined as a numeric representation of the brightness of the captured image based upon the selected exposure mode of operation for the digital camera 100. Exposure modes, described below, include an average exposure for the entire captured image, a center-weighted exposure, a spot exposure, or other well known exposure modes.

An exposure value is calculated and the captured image and the calculated exposure value are stored into memory. The stored calculated exposure value is used as a reference exposure value, and is used for comparison with other exposure values in a manner described below.

Concurrently, a subsequent image is captured by the digital camera. The exposure value for the subsequent image is then calculated and compared to the reference exposure value. If the exposure value associated with the second captured image changes by at least a predefined amount, the exposure value change criteria, the exposure change detection system recognizes that a sudden light change event has occurred and that the user desires to record images associated with the detected sudden light change event. That is, the subsequent image is saved into memory. However, if the difference between the reference exposure value and the exposure value associated with a second captured image is less than the exposure value change criteria, no sudden light change event has occurred and the subsequent image is discarded.

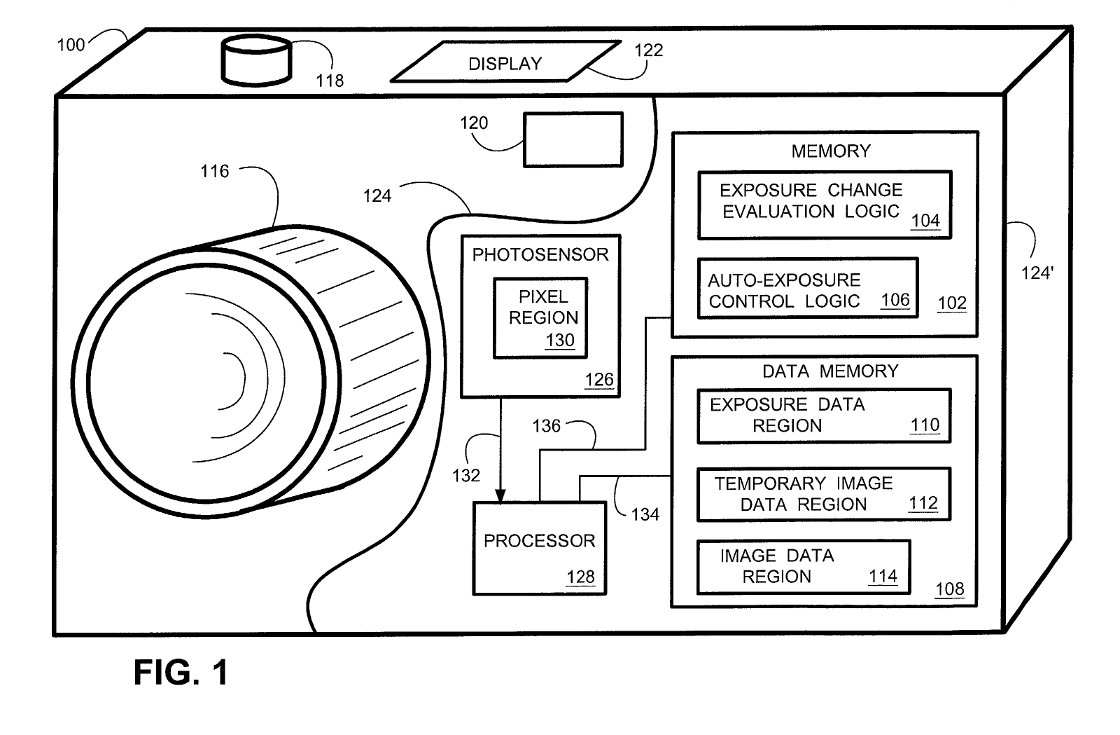

FIG. 1 is a block diagram illustrating selected internal components residing in a digital image capture device, digital camera 100, incorporating the exposure change detection system. Digital camera 100 includes at least memory 102 where the exposure change evaluation logic 104 and the auto-exposure control logic 106 reside. A data memory 108 is partitioned into at least an exposure data region 110 where the calculated exposure values are stored for analysis. Data memory 108, in one embodiment, includes the temporary image data region 112 so that the most recently captured image, or plurality of recently captured images, are stored until a determination is made as to whether or not the images are to be saved. Data memory 108 also includes an image data region 114 such that images residing in the temporary image data region 112, once such images are determined to be desired, are saved for the user of the digital image capture device 100. That is, when the exposure change detection system determines that a sudden light change event has occurred, as determined by a comparison of calculated exposure values associated with captured images, the images residing in the temporary image data region 112 are transferred to the image data region 114. Thus, the available memory capacity of the data memory 108 is more efficiently utilized because only the images associated with the sudden light change event are stored into the image data region 114. Since the digital camera 100 is continuously capturing images and analyzing exposures of each captured image, undesirable images (not associated with sudden light change events) are deleted from memory so that memory capacity is saved for subsequently captured images that are stored in the temporary image data region 112. The temporary image data region 112, in one embodiment, is a volatile type memory such as, but not limited to, a dynamic random axis memory (DRAM) or a flash memory.

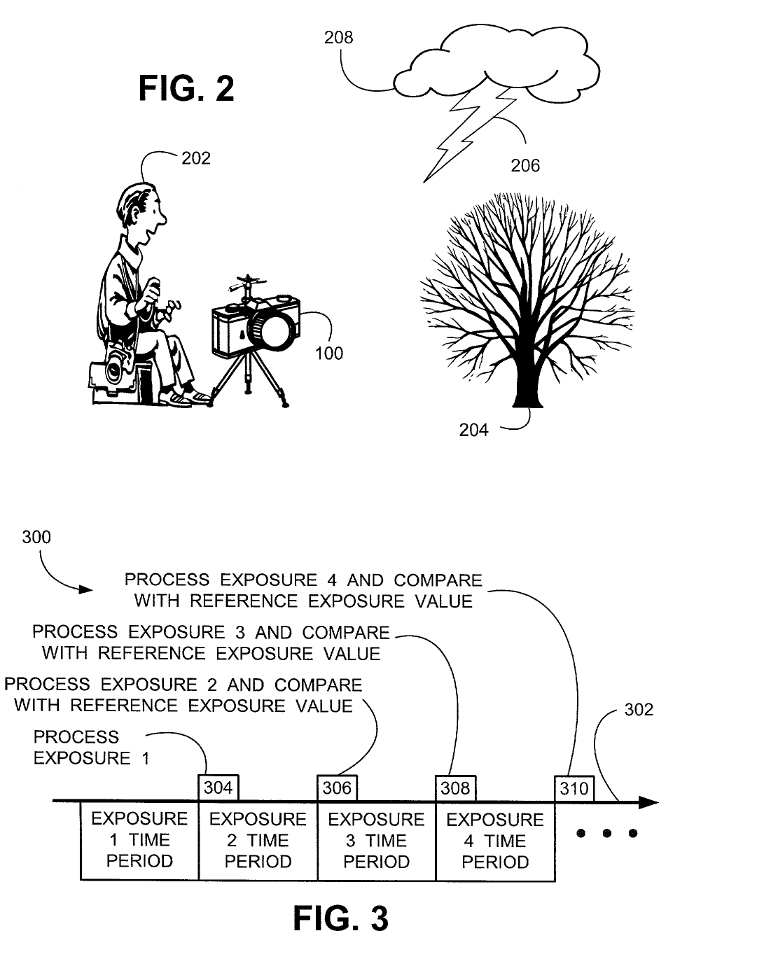

FIG. 2 is an illustrative diagram showing the deployment of the digital camera 100 in the field 200 to capture images associated with a sudden, unpredictable light change. The person 202 using the digital image capture device 100 positions the digital camera 100 and configures the various camera settings to desired values. Here, the person 202 is illustrated as positioning the digital camera 100 to “photograph” the tree 204. The person 202 is desiring to capture an image of the tree 204 when lit by lightning 206 from the cloud 208.

With a conventional camera, a person attempting to accomplish the same photographing of the tree 204 during the occurrence of lightning 206 must manually time the photographing of the tree 204 just as the brief and unpredictable lightning 206 is generated from the cloud 208. One skilled in the art will appreciate that the manual capturing of desirable images during the brief and unpredictable provided by lightning 206 is problematic at best. Alternatively, a person attempting to photograph tree 204 during the presence of the lightning 206 may attempt to capture a continuous sequence of images in the hopes that the lightning 206 will be generated from the cloud 208 during the time that the user of the conventional camera is capturing the plurality of successive images. However, one skilled in the art will appreciate that because such a conventional camera has a limited capacity for capturing images, the occurrence of the lightning 206 during the time that the user of the conventional camera is capturing the plurality of successive images is problematic at best. Furthermore, when the limited available capacity of the conventional camera is fully utilized, the user of the conventional camera must stop capturing images and either replace the film in a film formatted camera or erase the memory of a digital formatted camera. If during this time the lightning 206 is generated by the cloud 208, the user of the conventional camera will not be successful in capturing the desired images. Furthermore, with a conventional film formatted camera, the film having the undesirable images represents an undesirable cost to the user of the conventional film formatted camera in that a large number of undesirable images are captured on the film.

Returning to FIG. 2, the person 202 may efficiently and reliably capture a plurality of images of the tree 204 when the tree is lighted by lightning 206. Once the person 202 has properly positioned digital camera 100 and set the camera control setting to desired values, the digital camera 100 begins capturing images of the tree 204 on an on-going basis. When lightning 206 is not present, the exposure value associated with the captured image is calculated and stored in the exposure data region 110 of the data memory 108 (FIG. 1). The corresponding image is also saved into the temporary image data region 112 (FIG. 1). This stored exposure value is used as a reference exposure value for comparison with the exposure values associated with subsequently captured images.

In one embodiment, the subsequent image is stored into the temporary image data region 112 and the exposure data associated with the subsequent captured image is calculated and then compared to the reference exposure value. If there is no significant difference between the two exposure values, then the exposure change detection system determines that there has been no sudden light change event (the generation of lightning 206 from cloud 208).

When the lightning 206 is generated by cloud 208, the light from the lightning 206 increases the lighting of the tree 204. Since digital camera 100 is continuously capturing images of tree 204, when the tree 204 is “lighted up” by lightning 206, an image of the tree 204 is captured. The calculated exposure value of the image of the tree lighted up by the lightning 206 will have a higher calculated exposure value than the reference exposure value. In one embodiment, the reference exposure value is updated with the exposure value of the immediately preceding captured image. Thus, with this embodiment, the reference exposure value would be determined from the image captured just prior to the generation of lightning 206 from the cloud 208. Since the difference between the calculated exposure value of the image of the tree lighted up by the lightning 206 and the reference exposure value exceeds the exposure value change criteria, the exposure change detection system determines that a sudden light change event has occurred and recognizes that the most recently captured image is a desirable image. Accordingly, the image of tree 204 that is lighted up by the lightning 206 is moved from the temporary image data region 112 over into the image data region 114 for storage. Furthermore, as will be described hereinbelow, the person 202 may select from a variety of features that allows the storing of a plurality of images captured before and/or after the sudden light change event.

b. Image Capture Device Employing the Exposure Change Detection System

For convenience of illustrating the digital camera 100 in FIG. 1, the digital camera 100 is illustrated as a generic version of a digital camera typically used to capture digital still images. However, digital camera 100 includes additional components for capturing, or “photographing,” images. For example, digital camera 100 includes a lens unit 116, an image capture actuation button 118, a viewing lens 120 and a display 122. Lens unit 116 is a well known device used for the focusing of the image prior to the “photographing” of the image. When the person 202 (FIG. 2) has positioned the digital camera 100 and focused the image to be “photographed,” and is satisfied with the nature of the image that will be captured by the digital camera 100, the person 202 actuates the image capture actuation button 118 to cause the digital camera 100 to begin sequentially recording a plurality of digital images. Detailed operation of these above-described individual components residing on the digital camera 100 are not described in detail herein other than to the extent necessary to understand the operation and functioning of these components when employed as part of the exposure change detection system.

Digital camera 100, or other digitally based image capture devices, also has additional components not shown in FIG. 1. Such components are not discussed herein as such components are not necessarily relevant to the operation of a digital camera 100 when employed with the exposure change detection system. Furthermore, for convenience of illustration, the digital camera 100 is illustrated from a perspective that shows only the front, top and side views of the digital camera 100. Digital camera 100 has additional components residing on the hidden sides of the digital camera 100 not illustrated or discussed herein as such components are not necessarily relevant to the operation of a digital camera 100 when employed with the exposure change detection system. However, such components will be described as required below should such components (not shown) become relevant to the operation of a digital camera 100 with respect to the exposure change detection system.

Furthermore, for convenience of illustration and for explaining the operation and functionality of the digital camera 100 employing an exposure change detection system, the appearance of the digital camera 100 indicates that the digital camera 100 is particularly suited for the capturing of digital still images. However, such a digital camera 100 is easily adapted to capture digital video images. Furthermore, it is intended that the exposure change detection system perform equally well with other types of image capture devices (not shown). For example, but not limited to, a digital video camera or a digital motion picture camera are equally adaptable in a manner described below such that the digital video camera or the digital motion picture camera operates with the exposure change detection system. Furthermore, as described below, the exposure change detection system functions equally well in conventional film formatted still or video cameras. Any such variations in an image capturing device configured to operate in accordance with the present invention is intended to be within the scope of this disclosure and to be protected by the accompanying claims for the exposure change detection system.

FIG. 1 illustrates selected internal components residing in the digital camera 100 that are configured to operate in cooperation with the exposure change detection system. Cut-away lines 124 and 124′ demark components residing on the outside surfaces of digital camera 100 and components residing internally in digital camera 100. Thus, lens unit 116, image capture actuation button 118, viewing lens 120 and display 122 are recognized as components residing on the surface of digital camera 100.

Digital camera 100 includes a photosensor 126. Like a conventional digital camera or digital image capturing device, digital camera 100 records the digital image to be “photographed” on photosensor 126. Photosensor 126 is an array of many individual light sensing elements. Each individual light sensing element, referred to as a pixel, gathers light over a period of time. During the time period allocated for the gathering of light, each pixel gathers light such that the total amount of light gathered during the allocated time period corresponds to the brightness of that portion of the object of interest for which that pixel is detecting. Also, pixels may be fabricated to be sensitive to a particular frequency range of light, thereby providing for the detection of color. Photosensor 126 includes, in one embodiment, a pixel region 130.

Digital camera 100 includes a processor 128. Processor 128 is at least configured to receive signals from photosensor 126, via connection 132. Light from an image is detected by photosensor 126. Information corresponding to the image is received by processor 128 from the photosensor 126. Processor 128 transmits data corresponding to the digital image, via connection 134, for storage into memory 108 in the image data region 114.

In one embodiment of digital camera 100, processor 128 executes the auto-exposure control logic 106 to automatically determine and set various features of the digital camera 100. For example, auto-exposure control logic 106 is configured in one embodiment to determine and set the aperture and shutter speed, or their digital equivalents, based upon the targeted image that is to be photographed. That is, the auto-exposure control logic 106 is continuously evaluating light conditions to determine the proper exposure settings for the image that is to be captured. In another embodiment, the auto-exposure control logic is implemented as firmware, or a combination of hardware and firmware. When implemented as hardware, the auto-exposure control logic 106 is constructed with commonly available components well known in the art. For example, but not limited to, the auto-exposure control logic 106 may be implemented as a suitable configuration of transistors on an integrated circuit (IC) chip. Another embodiment provides for bypassing the auto-exposure control logic 106 such that the operator of camera 100 manually determines and selects the desired camera settings. Some embodiments do not include the auto-exposure control logic 106. One skilled in the art of designing and implementing digital cameras, with or without the auto-exposure control logic 106, will appreciate that many alternative configurations of the components (not shown) residing in digital camera 100 may be implemented having the above-described functionality and operation, and that such embodiments are too numerous to conveniently describe in detail herein. Any such implementation of digital camera 100 are intended to be within the scope of this disclosure and be protected by the accompanying claims for the exposure change detection system.

Detailed operation of the photosensor 126, processor 128 and memory 108 are well known conventional components employed in the art of capturing digital images and are therefore not described in detail herein other than to the extent necessary to understand the operation and functioning of these components when employed as part of the exposure change detection system. Furthermore, one skilled in the art will realize that a digital camera 100 or other digital image capture devices may have the components shown in FIG. 1 connected in a different order and manner than shown in FIG. 1, or may not include all of the components shown in FIG. 1, or may include additional components connected in some other manner with the components shown in FIG. 1 without affecting the operation and functionality of the digital camera 100 when operated as part of the exposure change detection system. Any such variations in a digital camera 100 or a similarly configured image capture device are intended to be within the scope of this disclosure and to be protected by the accompanying claims.

C. Determining and Comparing Exposure Values

FIG. 3 is a time line diagram 300 illustrating the exposure change analysis process employed by the digital camera 100 (FIG. 1). Thus, time line 302 graphically illustrates a sequential process of capturing images. For purposes of conveniently illustrating this process of capturing images, the time line 302 has not been numbered with specific time intervals. One skilled in the art will realize that any appropriate time numbering system could have been employed that corresponds to the operating characteristics of a digital camera 100, and that such a time numbering system is not necessary to explain the process of sequentially capturing a plurality of images with the digital camera 100 and the associated processing of the exposure values by the exposure change detection system of the present invention.

As described above, the person 202 initially positions digital camera 100 (FIG. 2) to capture an image of the object of interest. After person 202 has determined and set the camera control features, the person 202 actuates the image capture actuation button 118 (FIG. 1) such that the digital camera 100 begins the process of sequentially capturing a plurality of images of the object of interest. That is, when person 202 actuates the image capture actuation button 118, the digital camera 100 begins to take a series of “photographs” of the object of interest.

A finite time is required for photosensor 126 (FIG. 1) to capture sufficient light from the object of interest so that a representative digital image may be constructed from the captured light. This finite amount of time is represented by the exposure 1 time period of FIG. 3. At the end of the exposure 1 time period, the image data is processed to determine the exposure value. This calculated exposure value is saved as the reference exposure value into the exposure data region 110 (FIG. 1). This exposure value calculation process also requires a brief amount of finite time, as indicated by the time period 304.

After the end of the exposure 1 time period, the photosensor 126 begins accumulating light for the second image. The time period required to capture sufficient light for the second image is identified by the exposure 2 time period. Thus, during the exposure 2 time period, the photosensor 126 is capturing light and the processor 128 (FIG. 1) is executing the exposure change evaluation logic 104 (FIG. 1) such that the exposure value associated with the image capture during the exposure 1 time period is calculated (and saved as the reference exposure value).

When sufficient light has been captured by photosensor 126 for the second image, processor 128 receives the light data from photosensor 126 and stores image data corresponding to the light data into the temporary image data region 112 of data memory 108 (FIG. 1). Then, processor 128 executes the exposure change evaluation logic 104, at time period 306 such that the exposure value associated with the second image is determined. This second exposure value associated with the second image is then stored in the exposure data region 110 (FIG. 1). Concurrent with the calculation of the second exposure value associated with the second captured image (time period 306), photosensor 126 is capturing light for a third image (during the exposure time period 3). Thus, the digital camera 100 is recording light data captured by the photosensor 126 such that a continuous sequence of images are captured and saved in the temporary image data region 112.

Additionally, during time period 306, the exposure change evaluation logic 104 instructs processor 128 to retrieve the reference exposure value from the exposure data region 110 and compare the reference exposure value with the second exposure value associated with the second image. If the change between the second exposure value and the reference exposure value is at least equal to a predefined amount, the exposure value change criteria, the exposure change detection system recognizes that a sudden light change event has occurred. If the exposure change detection system determines that a sudden light change event has occurred, the second image is retrieved from the temporary image data region 112 and saved into the image data region 114. Thus, desired images associated with sudden light change events are captured and saved in an efficient manner that minimizes the amount of limited memory capacity because unwanted images (images not associated with the sudden light change event) are not saved into the image data region 114.

As will be described below, alternative embodiments may elect to save the first image into the image data region 114. Similarly, another embodiment may elect to save a predefined number of subsequently captured images into the image data region 114.

In yet another alternative embodiment, processor 128 may simply identify desired images that are to be saved such that the image data need not be moved from one region in data memory 108 to another region in data memory 108. In such an alternative embodiment, the data associated with undesirable images (images not associated with a sudden light change event) are simply overwritten as required during the process of capturing a plurality of sequential images while waiting for the occurrence of a sudden light change event. Thus, this alternative embodiment is implemented without the temporary image data region 112.

In yet another alternative embodiment, the temporary image data region 112 and the image data region 114 may each exist on different media formats. In such an alternative embodiment, the digital camera 100 may employ a plurality of data memories 108. For example, but not limited to, the temporary image data region 112 may be a conventional flash memory with limited storage capacity, and the image data region 114 may be a larger random access memory (RAM) optimally configured for the sequential storage of image data. A non-exhaustive list of other computer-readable medium suitable for storing desired images associated with a sudden light change event include a portable computer diskette (magnetic), an erasable programmable read-only memory (EPROM), an optical storage medium, or a portable compact disc (CD). In some embodiments of a digital camera 100, the image data region 114 may be configured to be removable from the digital camera 100 and coupled to other devices such that the captured image data may be conveniently transferred to the other devices and further processed by the user. Detailed operation of these above-described memory embodiments are well known in the art of managing digital data associated with captured images. Therefore, detailed explanation of the operation and configuration of these various memory embodiments are not described in detail herein other than to the extent necessary to understand the operation and functioning of these memory embodiments when employed as part of the exposure change detection system. Any such variations in the configuration of the memories configured to operate in accordance with the present invention are intended to be within the scope of this disclosure and to be protected by the accompanying claims for the exposure change detection system.

Returning now to FIG. 3, if at time period 306 the comparison of the second exposure value with the first exposure value does not satisfy the exposure value change criteria, the exposure change evaluation logic 104 recognizes that a sudden light change event has not yet occurred. In one embodiment, the reference exposure value is updated by replacing the reference exposure value with the second exposure value. With this embodiment, the reference exposure value is continuously updated with the exposure value of the immediately preceding captured image.

Upon the conclusion of the time period necessary to capture sufficient light for the third image, denoted by the exposure 3 time period, processor 128 again executes the exposure change evaluation logic 104 to calculate the third exposure value associated with the captured third image (during time period 308). After the calculation of the third exposure value at time period 308, the third exposure value is compared with the reference exposure value to determine if the sudden light change event occurred during the capturing of the data for the third image. Similarly, light data is captured by photosensor 126 during the time period denoted by the exposure 4 time period such that a fourth image is captured. At time period 310, the fourth exposure value associated with the fourth image is computed and then compared with the reference exposure value to determine if a sudden light change event has occurred. The above-described process proceeds in a continuous fashion, thereby capturing the images of interest that are associated with the sudden light change event in an efficient manner that requires a minimal amount of data memory 108 capacity.

In one embodiment, the temporary image data region 112 is a relatively small special purpose memory region (or device) having limited capacity for storage of digital image data. In another embodiment, the storage capacity of the temporary image data region 112 is sufficient for storing only one image. In this embodiment, at the conclusion of each exposure time period, the previously captured image data is overwritten with the most recently captured image data. An alternative embodiment employs a temporary image data region 112 having sufficient capacity for the storage of a plurality of images. In this embodiment, the most recently captured image overwrites the oldest captured image residing in the temporary image data region 112.

As described above, processor 128 executes the exposure change evaluation logic 104 (FIG. 1) to compute an exposure value for the light data collected by photosensor 126 during the capturing of image data. The exposure value may be calculated from the digital image data residing in the temporary image data region 112 using any one of a variety of well known techniques employed in the art of calculating exposure values from digital image data. One embodiment of digital camera 100 calculates exposure values based upon scene brightness. Scene brightness is typically measured in candelas per square meter, a non-linear scale. Typical scene brightness values in candelas per square meter (Can/M²). Some typical scene brightness values include, but are not limited to, a 0.3 Can/M² for a candlelit dinner, 2-8 Can/M² for the interior of a typical home, 15-50 Can/M² for the interior of a typical office, 100-400 Can/² for outside ambient light conditions on an overcast, cloudy day, and 1,000-9,000 Can/M² for outside ambient light conditions on a bright sunny day. In one embodiment, exposure values associated with scene brightness are computed by applying a logarithmic formula to the image data corresponding to the light captured by the photosensor 126. Thus, an exposure value is computed for each captured image such that the computed exposure values are compared with the reference exposure value to determine if a sudden light change event has occurred. One skilled in the art will appreciate that an exposure value, or any other value associated with the scene brightness of the captured image, may be computed, calculated or determined employing any variety of well known techniques and methods employed in the art of capturing digital images. In one embodiment, the logic and method of determining exposure values is inherently included in the auto-exposure control logic 106. Thus, one embodiment of the present invention is taking advantage of existing features and devices employed within the digital camera 100 such that the present invention, an exposure change detection system, may be practiced with a minimal addition of new components and/or with the minimal utilization of already limited memory resources.

In one embodiment, the exposure value for the image data is calculated based upon the average light of the entire scene that is photographed by digital camera 100. Calculating the exposure value based upon the average exposure is particularly suited for landscape scenes, portrait scenes, or other scenes having a substantially consistent average value of brightness across the entire scene.

Another method may center-weight the exposure value calculation by calculating the exposure value based upon the center portion of the scene. For example, but not limited to, the center half of the scene of a one mega pixel sensor would use the center 500,000 pixels to determine the center-weighted exposure value. Such a predefined region used in a center-weighting exposure value calculation method is illustrated by the pixel region 130 residing in the photosensor 126. Another center-weighted exposure value calculation technique employs a weighting process whereby the pixels residing in the central portion of the photosensor 126 are given a greater weight in the calculation of the exposure value than the pixels residing in the outer regions of the photosensor 126. Center-weighted exposure value calculation methods are particularly suitable when the brightness of the subject of interest is substantially different than the brightness of the scene background. Thus, digital camera 100 may be configured to optimally “photograph” the subject of interest.

Yet another exposure value calculation method designates a very small region, or spot, of pixels residing on the photosensor 126 for the calculation of the exposure value. One embodiment of digital camera 100 defines the spot as residing in the center of the scene. Another embodiment provides the flexibility for the user to select the location of the spot on the scene that is to be captured by the digital camera 100.

One skilled in the art will appreciate that many different methods may be used to calculate the exposure value and/or other values associated with the scene brightness and that such exposure value calculation methods are too numerous to conveniently describe in detail herein. Therefore, any embodiment of a digital camera 100 configured to operate in accordance with the present invention, the exposure change detection system, is intended to be within the scope of this disclosure and to be protected by the accompanying claims.

d. Operation and Functionality of the Exposure Change Detection System

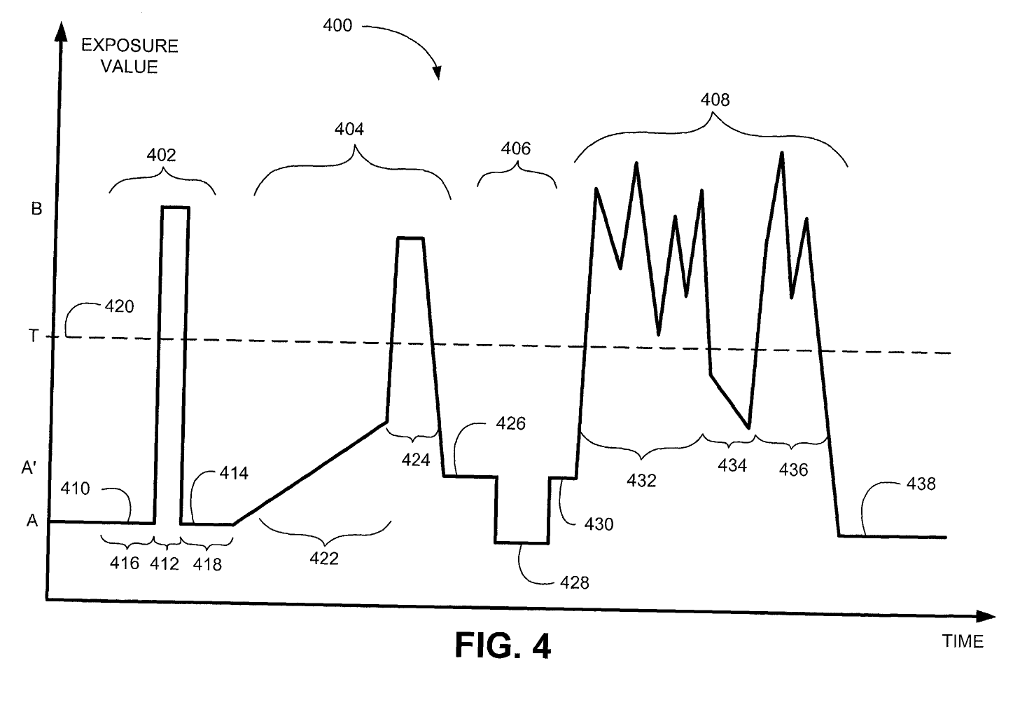

FIG. 4 is a chart 400 illustrating four simplified exemplary sudden light change events 402, 404, 406 and 408. The vertical axis of chart 400 represents the magnitude of the light associated with the light coming in through lens unit 116 and that is detected by the pixels residing in photosensor 126 (FIG. 1). The horizontal axis of chart 400 is a time axis. For purposes of conveniently illustrating the sudden light change events 402, 404, 406 and 408, the light magnitude axis has not been numbered. One skilled in the art will appreciate that any appropriate axis numbering system could have been employed, and that such a numbering system is not necessary to explain the nature of the sudden light change events 402, 404, 406 and 408. Similarly, the time axis of chart 400 has not been numbered. One skilled in the art will realize that any appropriate axis numbering system could have been employed for the time axis, and that such a numbering system is not necessary to explain the nature of the sudden light change events 402, 404, 406 and 408.

As described above, the person 202 using digital camera 100 (FIG. 2) positions the digital camera 100 such that the image of interest may be detected by the photosensor 126 (FIG. 1). The person 202 begins the process of capturing a continuous, sequential plurality of images by actuating the image capture actuation button 118 (FIG. 1). As the image capture process begins, an exposure value associated with each captured image is calculated. In FIG. 4, the initial calculated exposure value is denoted by exposure value A. Line segment 410 indicates that the initial calculated exposure values are substantially constant. The exemplary sudden light change event 402 is characterized by a nearly instantaneous increase in the exposure value up to an exposure value B. The bright light (denoted by exposure value B) continues for a brief period of time, denoted by the time encompassed by bracket 412. Then, the exposure value nearly instantaneously drops back to the exposure value A, as denoted by line segment 414. The exemplary sudden light change event 402 is intended to be representative of a simple, short duration sudden light increase. For example, the exemplary sudden light change event 402 may correspond to the flashing of a camera flash device or flash bulb, the rapid turning on and turning off of a bright light, the opening and closing of an aperture-like device, or the like. Since the sudden light change event 402 would typically occur at an unexpected time, a digital camera 100 employing the exposure change detection system detects the onset of the light change event 402 by computing the change in exposure values that correspond to the onset of the sudden light change, and thereby subsequently capture images of objects that are lighted by the sudden change in light (and/or capture images of the sudden light change source itself).

The above-described embodiment of the exposure change detection system is described as comparing two computed exposure values and determining the presence of a sudden light change event based upon the magnitude of the change of the exposure value. That is, when the difference between the two compared exposure values is at least equal to a predefined criteria, the exposure value change criteria, the exposure change detection system recognizes that sudden light change event has occurred. Thus, the digital camera captures the image associated with the increased exposure value.

An alternative embodiment of the exposure changed detection system computes the exposure value and compares the computed exposure value with a predefined threshold, denoted by the dashed line 420 having an exposure value T. In one embodiment, the threshold value T would be adjustable by the operator of the digital camera 100. Thus, when a sudden light change occurs such that the magnitude of the computed exposure value exceeds the threshold T, the exposure change evaluation logic 104 determines that a sudden light change event has occurred and initiates the saving of digital image data into the image data region 114 (FIG. 1).

With the embodiment that continually updates the reference value, after the exposure change detection system determines that a sudden light change event has occurred and has saved the associated captured image, the reference exposure value would be updated. A subsequently captured image would have a calculated exposure value that approximately equals the updated reference exposure value. Thus, this subsequently captured image would not be saved because there would be no substantial change in the computed exposure value and the updated reference exposure value. That is, the exposure value change criteria would not be satisfied, so the subsequently captured image would not be saved.

In an alternative embodiment, the user of the digital camera 100 may elect to save a predefined number of images after the onset of the sudden light change event. Or, the user may elect to continue capturing images until after the conclusion of the sudden light change event. Thus, the user of the digital camera 100 may capture a plurality of images during the time encompassed by bracket 412. Such an alternative embodiment may be particularly advantageous when the user desires to capture a plurality of images of the tree 204 (FIG. 2) when lightning 206 lights up the tree 204 during the several seconds that the lightning 206 exists. Alternatively, the person 202 using the digital camera 100 may desire to photograph the lightning 206 itself (or in combination with the tree 204). Thus, the person 202 is able to select the most desired images that are to be captured during the time encompassed by bracket 412.

Furthermore, the sudden light change event 402 is additionally characterized by a sudden decrease in light as denoted by the transition from the time period encompassed by bracket 412 to the time period encompassed by bracket 418. In one embodiment, the exposure change evaluation logic 104 (FIG. 1) would recognize the sudden decrease in light and initiate the capturing of images associated with the sudden decrease in light into the image data region 114 (FIG. 1) of data memory 108. That is, when the exposure value decreases from level B to level A, the digital camera 100 captures the image associated with a decreasing exposure value. Furthermore, the sudden decrease in light may be used to end the image capture process.

A second exemplary sudden light change event 404 is illustrated in FIG. 4. The sudden light change event 404 is preceded by a gradual increase in the exposure value, as denoted by the time encompassed by bracket 422. The sudden light change of interest is denoted by the increase of the exposure value to level B, and occurs at the beginning of the time period encompassed by bracket 424. During the time encompassed by bracket 422, the updated reference exposure value gradually increases with each successive captured image. Generally, the increase in the exposure value between successive images captured during the time encompassed by bracket 422 would not be characterized by changes in exposure values sufficient to indicate to the exposure change evaluation logic 104 that a sufficiently large sudden light change event has occurred. Only upon the sudden rapid change in light, as noted by the transition between the time encompassed by bracket 422 and the time encompassed by bracket 424, would the exposure change evaluation logic 104 determine that a sudden light change event of interest has occurred. In many instances, the operator of the camera may not desire to capture images associated with the gradual increase in the exposure value during the time period encompassed by bracket 422. An embodiment that continually updates the reference exposure value would thereby avoid capturing images associated with the gradually increasing light levels during the time encompassed by bracket 422.

An illustrative non-limiting example of the exemplary sudden light change event 404 would occur when the operator of the camera is wanting to capture the image of the sun rising in the morning over a background such as a mountain or ocean. As the sun begins rising during the pre-dawn period, the computed exposure value gradually increases as the light level increases, denoted by the time encompassed by bracket 422. Images associated with the time encompassed by bracket 422 would not be saved because the exposure value is continuously updated. As the sun crests the background scene, the direct sunlight falling upon the photosensor 126 would cause a sudden and rapid change in the computed exposure value, thereby causing the capturing and storing of an image because the difference between the computed exposure value and the referenced exposure value exceeds the exposure value change criteria. Thus, the user could capture the sun cresting the background horizon.

When comparing the exemplary sudden light change event 402 with the sudden light change event 404, it is apparent that the magnitude of the exposure value change when the sudden light change occurs is quite different for the sudden light change events 402 and 404. Thus, one embodiment of the exposure change detection system enables the user to vary the exposure value change criteria that indicates to the exposure change evaluation logic 104 that a sudden light change event has occurred. That is, the user may select the magnitude of light change for which the exposure change evaluation logic 104 is to recognize as a sudden light change and thereby initiate the storing of image data into the image data region 114.

A third exemplary sudden light change event 406 is illustrated in FIG. 4. Upon the conclusion of the sudden light change event 404, occurring at the end of the time period encompassed by bracket 424, the exposure value is illustrated as decreasing to an exposure value level of A′, as denoted by line segment 424. For illustration purposes, images captured when the exposure values are equal to A and A′ are not images that the user of digital camera 100 is interested in saving. However, the difference between the exposure value A and the exposure value A′ may be sufficiently great, and thereby satisfy the predefined exposure value change criteria, such that the exposure change evaluation logic 104 may erroneously conclude that a sudden light change event has occurred when the exposure value transitions from A′ to A, or from A to A′, as denoted by the time period encompassed by line sections 426 and 428, and line sections 428 and 430, respectively. One embodiment avoids the erroneous conclusion that a sudden light change of interest has occurred by configuring the exposure change evaluation logic 104 to evaluate both the change in the exposure value between two successive captured images and the magnitude of the exposure value. Thus, even though the change in exposure value satisfies the exposure value change criteria, the exposure change evaluation logic 104 would not instruct processor 128 to save images into the image data region 114 because the exposure value of the images did not at least equal the threshold T.

A fourth exemplary sudden light change event 408 is illustrated in FIG. 4. The sudden light change event 408 begins at the start of the time encompassed by bracket 432. Here, the sudden light change of interest is characterized by a rapid and unpredictable fluctuation of the exposure value during the time encompassed by bracket 432. During the time encompassed by bracket 434, the sudden light change event is illustrated as rapidly and unpredictably decreasing below the threshold value T. During the time encompassed by bracket 436, the exposure value rapidly and unpredictably increases again and varies at exposure values greater than threshold T. Upon the conclusion of the sudden light change event 408, occurring at the end of the time encompassed by bracket 436, the exposure value decreases to level A, as denoted by line segment 438.

The exemplary sudden light change event 408 is intended to illustrate exposure values that are expected to be associated with the lightning 206 (FIG. 2). If the person 202 is capturing images of tree 204 with the digital camera 100, the effect of the lightning 206 would be to change the lighting of the tree 204, thereby causing a change in the exposure value as indicated by the sudden light change event 408.

Comparing the sudden light change event 408 to the sudden light change events 402, 404 and 406, the sudden light change event 408 spans a much longer relative time period. One embodiment of the digital camera 100 includes a feature that allows the user 202 to specify a period of time or to specify a number of images that will be captured after the detection of the sudden light change event 408 (indicated by the exposure value change at the start of the time encompassed by bracket 432). Thus, the person 202 may capture a plurality of successive images that span the entire time period encompassed by the sudden light change event 408.

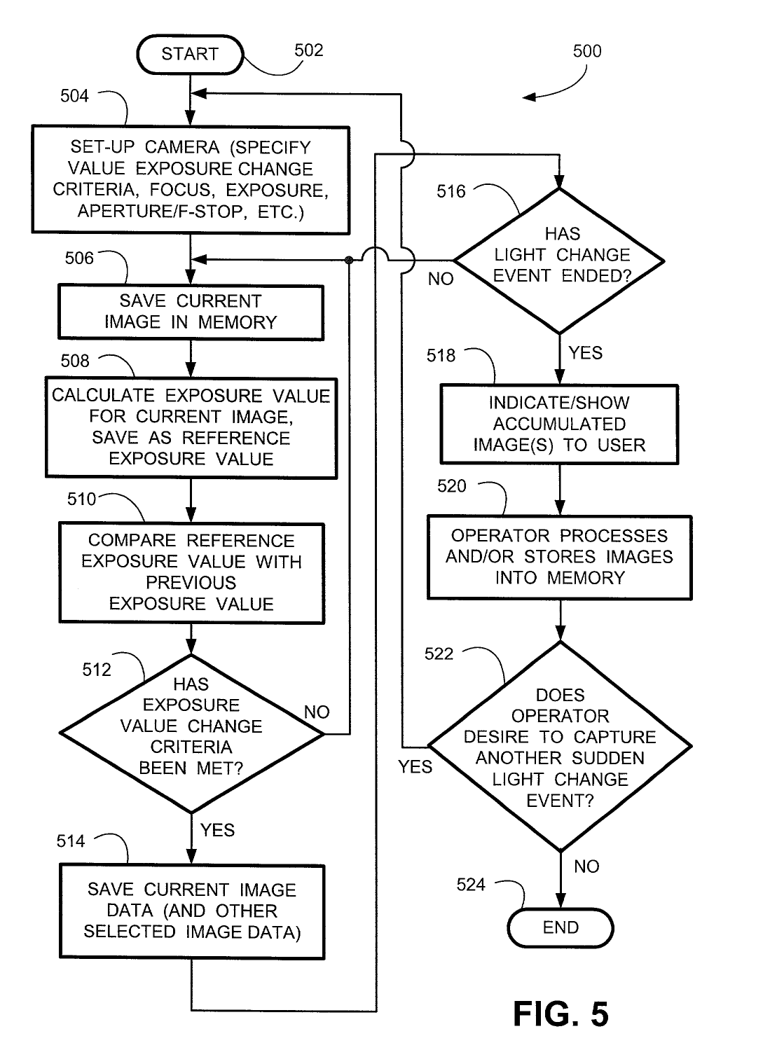

FIG. 5 is a flow chart illustrating the process of capturing images using the digital camera 100 (FIG. 1). The flow chart of FIG. 5 shows the architecture, functionality, and operation of a possible implementation of the software for implementing the exposure change evaluation logic 104 (FIG. 1). In this regard, each block may represent a module, segment or portion of code, which comprises one or more executable instructions for implementing the specified logical function(s). It should also be noted that in some alternative implementations, the functions noted in the blocks may occur out of the order noted in FIG. 5 or may include additional functions without departing significantly from the functionality of the exposure change detection system. For example, two blocks shown in succession in FIG. 5 may in fact be executed substantially concurrently, the blocks may be sometimes be executed in reverse order, or some of the blocks may not be executed in all instances, depending upon the functionality involved, as will be further clarified hereinbelow. All such modifications and variations are intended to be included within the scope of this disclosure for the exposure change detection system and to be protected by the accompanying claims. Furthermore, one skilled in the art will appreciate that the simplified illustrative flow chart 500 of FIG. 5 describes only one of the many above-described processes whereby the exposure change evaluation logic 104 is configured to detect a sudden light change event. Because of the numerous variations described herein, specific flow charts are not provided for each of the various alternative embodiments and methods described herein. One skilled in the art will readily appreciate that minor variations and alterations are necessary to the flow chart 500 of FIG. 5 to implement any one, or any combination of, the described alternative embodiments.

The process of practicing the present invention, the exposure change detection system, begins at block 502. At block 504, the person 202 (FIG. 2) sets up the digital camera 100 by positioning the digital camera 100 such that the desired scene may be photographed. The person 202 also configures the digital camera 100 to photograph the object of interest by configuring the user selectable features of the camera such as specifying the exposure value change criteria, focus, exposure, aperture/f-stop, etc. When the digital camera 100 is properly set-up, the process proceeds to block 506 when the person 202 actuates the image capture actuation button 118 (FIG. 1), as described above. At block 502, the current image detected by the photosensor 126 (FIG. 1) is stored into the temporary image data region 112 of data memory 108. Next, the exposure change evaluation logic 104 is executed by processor 128 to calculate the exposure value for the current image, as shown at block 508. Also, at block 508, the exposure value for the current image is saved as the reference exposure value.

At block 510, the current exposure value data is compared with the reference exposure value. At block 512, the calculated change between the current exposure value and the reference exposure value is compared with the exposure value change criteria. If the difference between the exposure values is not at least equal to the exposure value change criteria (the NO condition), the process returns to block 506 such that the next image is processed in the above-described manner. That is, at block 512, if the change in the exposure value is not at least equal to the exposure value change criteria, the exposure change evaluation logic 104 has determined that a sudden light change event has not occurred. Furthermore, by returning the process back to block 506, the reference exposure value is updated.

However, if at block 512 the change in the exposure value is at least equal to the exposure value change criteria (the YES condition), the process proceeds to block 514 such that the current image data is saved into the image data region 114 of the data memory 108. That is, at block 512, if the change in the exposure value data is at least equal to the exposure value change criteria, the exposure change evaluation logic 104 has determined that a sudden light change event has occurred. Furthermore, depending upon the option selected by the user of the camera 100, other images may be saved into the image data region 114.

In one embodiment, the process proceeds to block 516. At block 516, a determination is made whether or not the light change event has ended. The ending of the light change event is simply determined by comparing the change in exposure data in much the same manner as described in blocks 506 through 512. With this embodiment, if the light change event has not ended (the NO condition), the process proceeds back to block 506 such that additional images are evaluated. However, if the light change event has ended (the YES condition), the process proceeds to block 518. At block 518, the digital camera 100 indicates to the user the accumulated images, and other relevant information, that were saved during the light change event. At block 520, the operator processes and/or re-saves the images. Then, at block 522, a determination is made whether or not the operator desires to capture another sudden light change event. If so (the YES condition), the process in one embodiment proceeds to block 504 such that the operator may reposition the digital camera 100 or change the various user selectable options. Another embodiment may return directly back to block 506. However, if the operator does not desire to capture additional sudden light change events (the NO condition), the process ends at block 524.

e. Alternative Embodiment Employing the Exposure Change Detection System

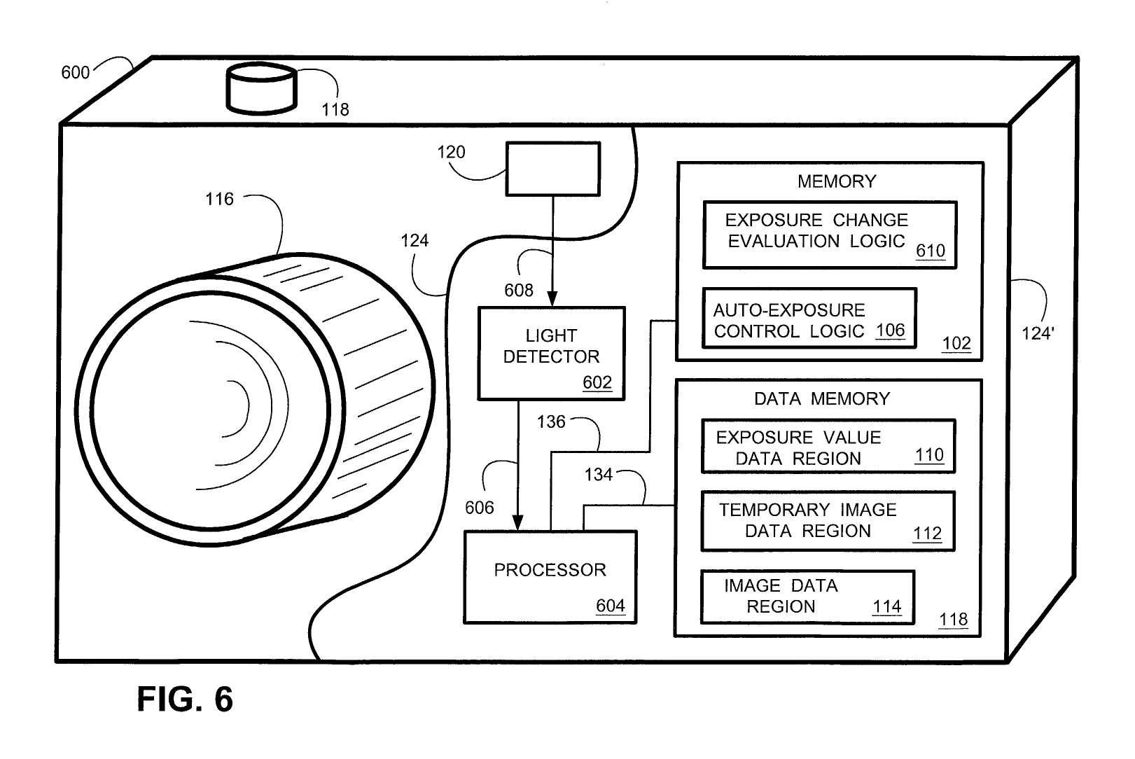

FIG. 6 is a block diagram illustrating an alternative embodiment of an image capture device, camera 600, employing a light detector 602. Camera 600 is similar to the digital camera 100 (FIG. 1) in that many of the features and components necessary to perform the functionality of capturing images are the same. For example, but not limited to, camera 600 includes lens unit 116, image capture actuation button 118 and viewing lens 120. The functionality and operation of these components are described above. Cut-away line 124 and 124′ demark components residing on the outside surfaces of camera 600 and components residing internally in camera 600. Light detector 602 is coupled to processor 604 via connection 606 and is coupled to the viewing lens 120 via connection 608.

The light detector 602 detects the light level of the object of interest. Processor 604 executes the exposure change evaluation logic 610 to interpret the information provided by the light detector 602. That is, information provided by the light detector 602 corresponds to the exposure value calculated by digital camera 100 (FIG. 1). Processor 604 monitors information provided by the light detector 602 such that a sudden light change event is detected. Like the digital camera 100, images associated with the sudden light change event are saved into the image data region 114 of data memory 118.

In an alternative embodiment, the light detector 602 is disposed on the outside of the camera 600. Or, light detector 602 is disposed within camera 600 such that light passing into viewing lens 120 or lens unit 116 is detected.

In yet another embodiment, a light detector 602 is implemented in a film format camera. Processor 604 monitors information provided by the light detector 602 such that upon the detection of a sudden light change event, the processor 604 would initiate the actuation of the film formatted camera to open the camera shutter and expose the film such that a photograph is taken of the object of interest upon the onset of the sudden light event.

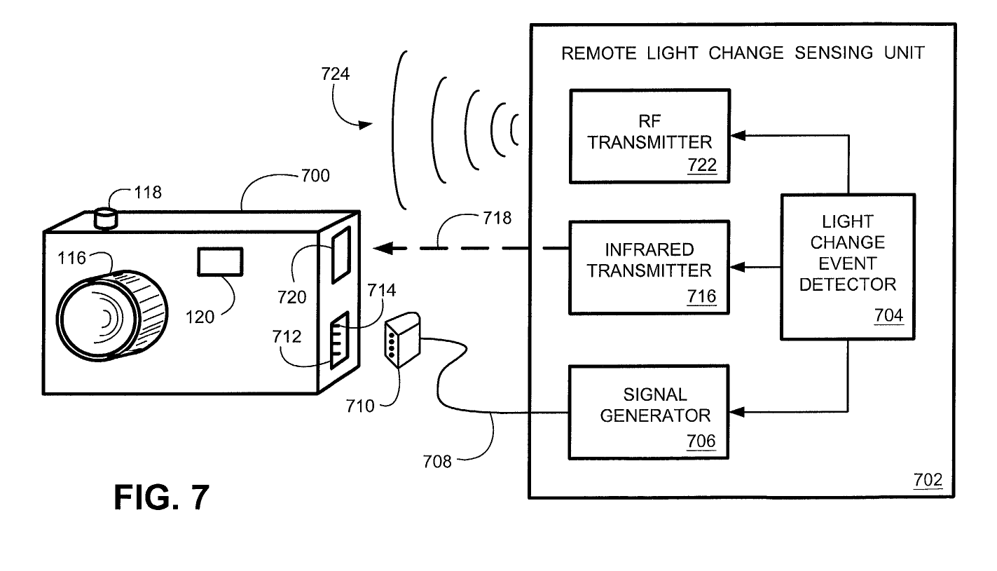

FIG. 7 is a block diagram illustrating an alternative embodiment of an image capture device, camera 700, employing a remote light sensing unit 702. Such an alternative embodiment of the camera 700 provides for the remote detection of a light change event. Camera 700 is similar to the digital camera 100 (FIG. 1) in that many of the features and components necessary to perform the functionality of capturing images are the same. For example, but not limited to, camera 700 includes lens unit 116, image capture actuation button 118 and viewing lens 120. The functionality and operation of these components are described above.

However, the remote light change sensing unit 702 includes at least a light change event detector 704. The light change event detector 704, in one embodiment, is a simple photosensitive element configured to detect changes in light. In other embodiments, the light change event detector 704 may be a device having a plurality of elements coupled together such that a sudden light change event may be detected and recognized. When a sudden light change event is recognized by the remote light change sensing unit 702, the remote light change sensing unit 702 communicates the occurrence of the sudden light change event to the camera 700.

One exemplary means for communicating the sudden light change event to the camera 700 includes a signal generator 706 residing in the remote light change sensing unit 702. Upon the detection of the sudden light change event by the light change event detector 704, the signal generator 706 generates and communicates a suitable signal onto connection 708. Connection 708 is coupled to camera 700 with a suitable plug-in connector 710 that plugs into the camera 700 at a suitable connection interface 712. In one embodiment, connection interface 712 includes a plurality of pins 714 configured to provide electrical connectivity to the plug-in connector 710.

An alternative embodiment of the remote light change sensing unit 702 may employ an infrared transmitter 716 to communicate the sudden light change event to the camera 700. Here, the infrared transmitter 716 is prompted by the light change event detector 704 to generate an infrared signal 718 which is sensed by the infrared sensor 720 residing in the camera 700. In yet another embodiment of the remote light change sensing unit 702, a radio frequency (RF) transmitter 722 is prompted to generate a radio signal 724 that is detected by an antenna (not shown) and a radio frequency (RF) receiver (not shown) residing in the camera 700.

A camera 700 employing a remote light change sensing unit 702 may be particularly suitable in a digital camera embodiment where the user desires to “aim” the light change event detector 704 at a specific position where the sudden light change event is expected to occur. Such a feature is advantageous in detecting localized light change events that might not provide a sufficient light change to be detected by other alternative embodiments of the digital camera 100. Furthermore, a remote light change sensing unit 702 is particularly advantageous when the user of the camera 700 desires to position the remote light change sensing unit 702 closely to the source of the light change. For example, the user of camera 700 may desire to capture wildlife scenes at night using motion sensor devices that trigger the actuation of one or more remotely placed light sources. When the animal passes into the viewing area of the camera 700, the motion detector would sense the presence of the animal and turn on the light sources. The remote light change sensing unit 702 is conveniently positioned to reliably detect the turning on of the light sources (the sudden light change event) and thereby more reliably ensure that the camera 700 begins the process of capturing images in response to the sudden light change event.

Yet another alternative embodiment of the exposure change detection system employs a rolling average reference exposure value to further refine the process of detecting a light change event. Here, a plurality of exposure values associated with a series of exposures are averaged together to compute a rolling average exposure value. For example, one embodiment calculates the rolling average reference exposure value by averaging the three preceding exposure values, and then compares the rolling average reference exposure value with the current exposure value. Such an embodiment, referring to FIG. 3, would average the reference exposure values calculated during time periods 304, 306 and 308, which are associated with images captured during exposure 1 time period, exposure 2 time period and exposure 3 time period, respectively. When the fourth image has been captured at the conclusion of the exposure 4 time period, the exposure value associated with the fourth image is then compared with the calculated rolling average reference exposure value. If a sudden light change event has occurred, as determined when the difference between the current exposure value and the rolling average reference exposure value is at least equal to the exposure value change criteria, the process of saving images into the image data region 114 (FIG. 1) of memory 118 is initiated. However, if a sudden light change event has not occurred, then the exposure values calculated during time periods 306, 308 and 310 are averaged together to calculate a new rolling average reference exposure value that will be compared with the next calculated exposure value. Such an embodiment may be particularly advantageous when the light levels are constantly changing, but the changing light levels are not sufficient to indicate the presence of a sudden light change event of interest. Alternative embodiments employing the rolling average reference exposure value feature compute the rolling average reference exposure value on any desirable number of calculated exposure values. In one embodiment, the number of exposure values used in the rolling average exposure value calculation is a user defined variable.

Yet another alternative embodiment of the exposure change detection system employs a fixed reference exposure value. Here, the operator of the digital camera selects a desired reference exposure value. Exposure values of all captured images are compared with the fixed reference exposure value to determine if a sudden light change event has occurred. One embodiment enables the user of the digital camera to capture an image having desired light levels that are used to determine the fixed reference exposure value. Another embodiment allows the user to numerically specify a fixed reference exposure value.

As described above, various user selectable features are provided in some embodiments of the image capture device employing the exposure change detection system of the present invention. Such embodiments of an image capture device would necessarily include a suitable operator control interface such that the desired features may be selected and/or adjusted by the user. For example, but not limited to, a suitable operator control interface may be implemented through a graphical user interface (GUI), a touch screen device, and/or knobs, dials, buttons, switches or the like. For example, one above-described feature combines the threshold feature and the exposure value change criteria. That is, the sudden light change event must be characterized by both a magnitude change in light that corresponds to the exposure value change criteria, and have a light magnitude that corresponds at least to the threshold, before images are saved. A suitable operator control interface for such a feature allows the user to select the exposure value change criteria feature, the threshold feature, or both. Another non-limiting example of a suitable operator control interface includes the feature of allowing the user to specify the time or number of images that are captured before, during, and/or after the sudden light change event. Here, the suitable operator control interface may provide a limited selection to the user, or provide for the user to variably select the time periods or number of images of interest. Embodiments of image capture devices implemented with the various above-described features, and that employ a suitable operator control interface, are particularly desirable in providing a wide range of products that are priced and marketed according to specific user interests and requirements.

It should be emphasized that the above-described embodiments of the present invention, particularly, any “preferred” embodiments, are merely possible examples of implementations, merely set forth for a clear understanding of the principles of the invention. Many variations and modifications may be made to the above-described embodiment(s) of the invention without departing substantially from the spirit and principles of the invention. All such modifications and variations are intended to be included herein within the scope of this disclosure and the present invention and protected by the following claims.

Now, therefore, the following is claimed:

1. A system for initiating capture of images:
a photosensor configured to capture an image;
a processor configured to execute logic for;
determining an exposure value for the image;
computing an exposure value change from a previous exposure value;
comparing the exposure value change to an exposure value change criteria; and
a memory configured to store the image when the exposure value change is at least equal to the exposure value change criteria.

2. A method for initiating capture of images, the method comprising the steps of:
determining an exposure value for the image;
computing an exposure value change from a previous exposure value;
comparing the exposure value change to an exposure value change criteria; and
capturing the image when the exposure value change is at least equal to the exposure value change criteria.

3. The method of claim 2, further comprising the step of calculating the previous exposure value from at least one previously captured image.

4. The method of claim 2, wherein the step of capturing further includes the step of storing the image in a memory.

5. The method of claim 4, wherein the step of capturing further includes the step of storing in the memory at least one subsequent image.

6. The method of claim 4, wherein the step of capturing further includes the step of storing in the memory at least one previously captured image.

7. The method of claim 2, wherein the step of capturing further includes the step of exposing the image to film.

8. The method of claim 2, wherein the image is a still image.

9. The method of claim 2, wherein the image is a video image.

10. The method of claim 2, further comprising the step of comparing the exposure value to a predefined threshold such that the step of capturing the image when the exposure value change is at least equal to the exposure value change criteria is performed when the exposure value is at least equal to the predefined threshold.

11. A system for initiating capture of images, comprising:
means for determining an exposure value for the image;
means for computing an exposure value change from a previous exposure value;
means for comparing the exposure value change to an exposure value change criteria; and
means for capturing the image when the exposure value change is at least equal to the exposure value change criteria.

12. The system of claim 11, further comprising the step of calculating the previous exposure value from at least one previously captured image.

13. The system of claim 11, wherein the means for capturing further includes means for storing the image in a memory.

14. The system of claim 13, wherein the means for capturing further includes means for storing in the memory at least one subsequent image.

15. The system of claim 13, wherein the means for capturing further includes means for storing in the memory at least one previously captured image.

16. The system of claim 11, wherein the means for capturing further includes means for exposing the image to film.

17. A computer readable medium having a program for initiating capture of images, the program comprising logic configured to perform the steps of:
determining an exposure value for the image;
computing an exposure value change from a previous exposure value;
comparing the exposure value change to an exposure value change criteria; and
capturing the image when the exposure value change is at least equal to the exposure value change criteria.

18. The system of claim 17, wherein the program is further configured to perform the step of calculating the previous exposure value from at least one previously captured image.

19. The system of claim 17, wherein the program is further configured to perform the step of storing the image in a memory.

20. The system of claim 19, wherein the program is further configured to perform the step of storing in the memory at least one subsequent image.

21. The system of claim 19, wherein the program is further configured to perform the step of storing in the memory at least one previously captured image.
